(19) United States
(12) Patent Application Publication
(10) Pub. No.: US 2026/0349184 A1
(43) Pub. Date: Nov. 5, 2026

(54) COMPACT DOME STYLE TELECOMMUNICATION ENCLOSURE

(71) Applicant: CommScope Technologies LLC, Claremont, NC (US)

(72) Inventors: Roel Modest Willy BRYON, Aarschot (BE); Johan GEENS, Bunsbeek (BE); Olmo BROOD, Berchem (BE)

(73) Assignee: CommScope Technologies LLC, Claremont, NC (US)

(21) Appl. No.: 19/474,422

(22) PCT Filed: Apr. 11, 2024
(86) PCT No.: PCT/US2024/024012

§ 371 Date: Oct. 10, 2025

Related U.S. Application Data
(60) Provisional application No. 63/495,495, filed on Apr. 11, 2023.

(51) Int. Cl. G02B 6/38; G02B 6/44

(52) U.S. Cl. CPC G02B 6/3825; G02B 6/3894; G02B 6/3897; G02B 6/4442; G02B 6/44528

(57) ABSTRACT

The present disclosure relates to an enclosure having a base and a dome. The based supports fiber optic adapters arranged in rows with the fiber optic adapters of adjacent rows being staggered with respect to each other. Fiber optic connectors are installed in inner ports of the fiber optic adapters. A fiber optic component holder is positioned within the dome at a location between adjacent connectors installed within fiber optic adapter of one of the rows.

### CROSS-REFERENCE TO RELATED APPLICATION

This application claims the benefit of U.S. Provisional Application No. 63/495,495 (filed Apr. 11, 2023), titled “Compact Dome Style Telecommunication Enclosure” the disclosure of which is hereby incorporated herein by reference.

### TECHNICAL FIELD

The present disclosure relates generally to fiber optic connection systems such as fiber optic connection systems integrated with enclosures.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances. Optical fiber connectors are an important part of most fiber optic communication systems. Fiber optic connectors allow two optical fibers to be quickly optically connected without requiring a splice. Fiber optic connectors can be used to optically interconnect two lengths of optical fiber. Fiber optic connectors can also be used to interconnect lengths of optical fiber to passive and active equipment.

A typical fiber optic connector includes a ferrule assembly supported at a distal end of a connector housing. A spring is used to bias the ferrule assembly in a distal direction relative to the connector housing. The ferrule functions to support an end portion of at least one optical fiber (in the case of a multi-fiber ferrule, the ends of multiple fibers are supported). The ferrule has a distal end face at which a polished end of the optical fiber is located. When two fiber optic connectors are interconnected, the distal end faces of the ferrules abut one another and the ferrules are forced proximally relative to their respective connector housings against the bias of their respective springs. With the fiber optic connectors connected, their respective optical fibers are coaxially aligned such that the end faces of the optical fibers directly oppose one another. In this way, an optical signal can be transmitted from optical fiber to optical fiber through the aligned end faces of the optical fibers. For many fiber optic connector styles, alignment between two fiber optic connectors is provided through the use of an intermediate fiber optic adapter.

Ruggedized (i.e., hardened) fiber optic connection systems include fiber optic connectors and fiber optic adapters suitable for outside environmental use. These types of systems are typically environmentally sealed and include robust fastening arrangements suitable for withstanding relatively large pull loading and side loading. Example ruggedized fiber optic connection systems are disclosed by U.S. Pat. Nos. 7,467,896; 7,744,288; and 8,556,520. It will be appreciated that a number of different types of ruggedized fiber optic connectors are available for outside environmental use. PCT International Publication Nos. WO2015/028433 and WO2021/041305 disclose systems for making fiber optic connectors in which a number of different ruggedized outer assemblies having different form-factors or configurations can be selectively mounted on a pre-terminated cable such that the pre-terminated cable can be customized to be compatible with a particular style or type of fiber optic connector or fiber optic adapter.

In fiber optic connector systems, optical connection density and ease of access are important factors that are conflicting. Systems having relatively high optical connection densities while maintaining easy access are desirable.

### SUMMARY

One aspect of the present disclosure relates to an enclosure having a base and a dome. The based supports fiber optic adapters arranged in rows with the fiber optic adapters of adjacent rows being staggered with respect to each other. Fiber optic connectors are installed in inner ports of the fiber optic adapters. A fiber optic component holder is positioned within the dome at a location between adjacent connectors installed within fiber optic adapter of one of the rows.

Another aspect of the present disclosure relates to an enclosure having an hardened adapter ports arranged in a configuration to enhance density while maintaining access.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the examples disclosed herein are based.

### BRIEF DESCRIPTION OF THE DRAWINGS

FIG. 1 depicts an enclosure in accordance with the principles of the present disclosure having outer connector ports arranged in a staggered, densely packed configuration.

FIG. 2 is a major side view of the enclosure of FIG. 1.

FIG. 3 is a minor side view of the enclosure of FIG. 1.

FIG. 4 is a bottom end view of the enclosure of FIG. 1.

FIG. 5 is an exterior, bottom end view of a base of the enclosure of FIG. 1 with the fiber optic adapters removed, with an exterior surface of the base and adapter mounting openings defined through the base being depicted.

FIG. 6 is an interior view of the base of FIG. 5 with the fiber optic adapters removed, with an interior surface of the base and the adapter mounting openings defined through the base being depicted.

FIG. 7 is an exploded view of one of the fiber optic adapters of the enclosure of FIG. 1.

FIG. 8 is a cross-sectional view of the fiber optic adapter of FIG. 7.

FIG. 9 is a cross-sectional view of the fiber optic adapter of FIG. 7 with a non-hardened fiber optic connector installed within an inner port of the fiber optic adapter.

FIG. 10 is a cross-sectional view of the fiber optic adapter of FIG. 7 with the non-hardened fiber optic connector installed within an inner port of the fiber optic adapter and a hardened fiber optic connector installed in an outer port of the fiber optic adapter.

FIG. 11 is a perspective view of the hardened fiber optic connector adapted to be received in an outer port of the fiber optic adapter of FIG. 7.

FIG. 12 is a first major side view of the enclosure of FIG. 1 with the dome removed.

FIG. 13 is a second major side view of the enclosure of FIG. 1 with the dome removed.

### DETAILED DESCRIPTION

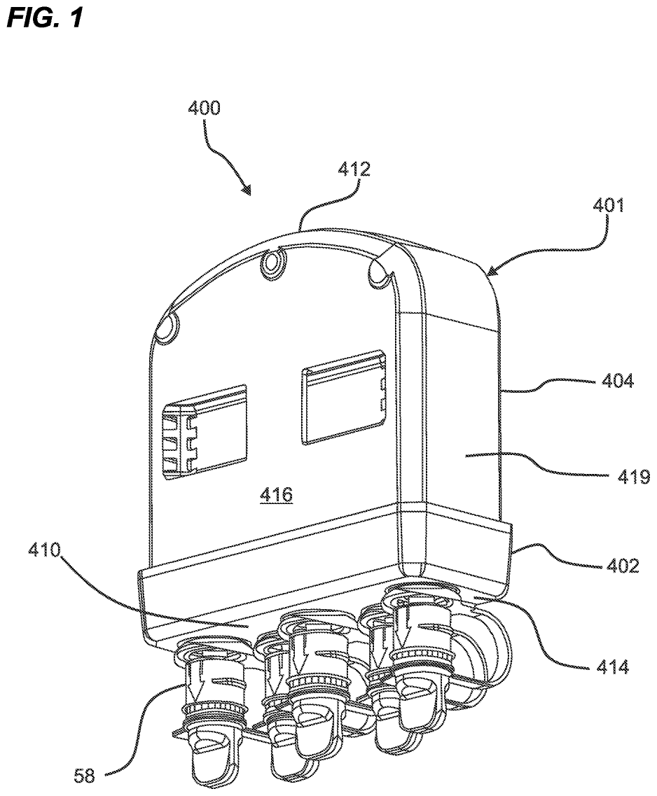

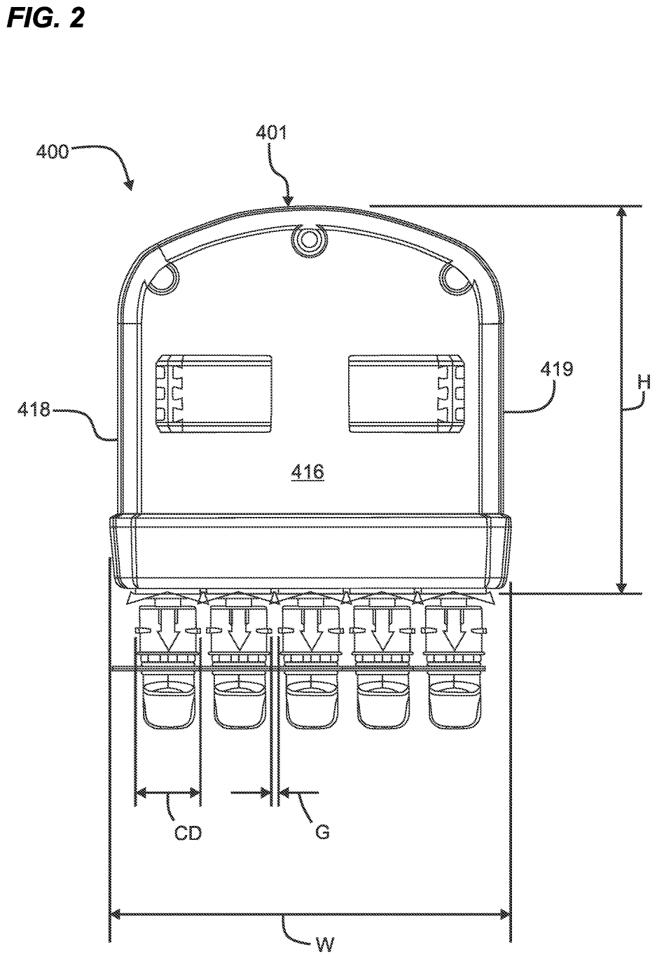

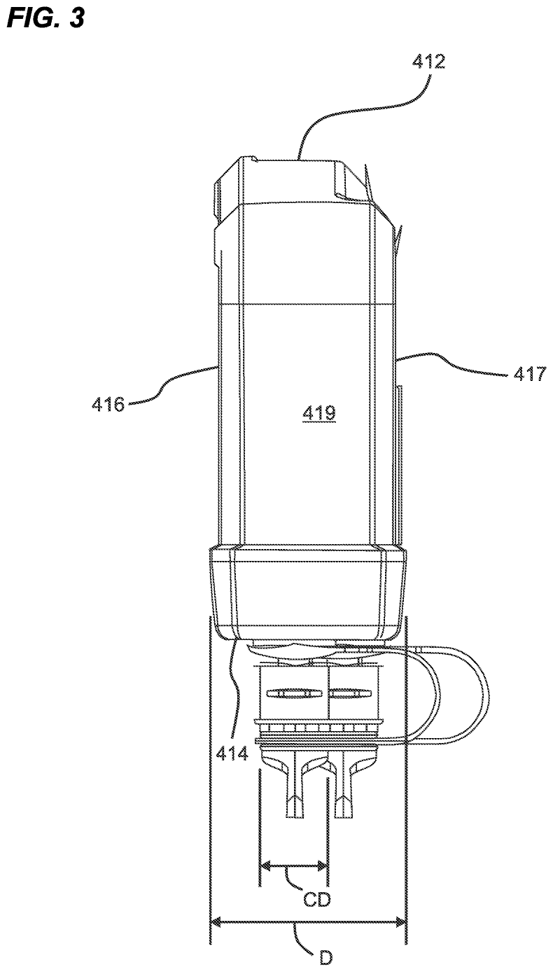

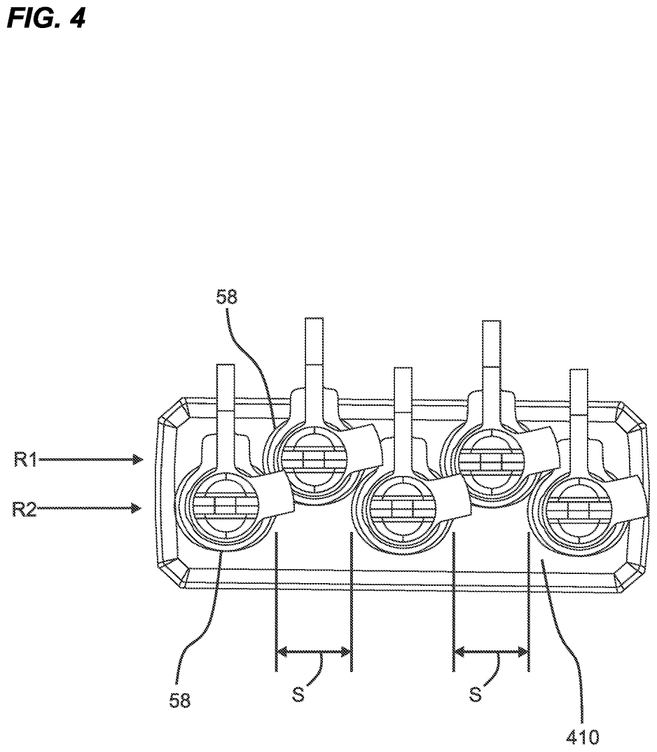

FIGS. 1-4 depict an enclosure 400 in accordance with the principles of the present disclosure including a housing 401 having a base 402 and a dome 404 that can be secured together in a sealed manner. First and second parallel rows R1, R2 of adapters 58 are provided at a bottom of the base so that the hardened ports of the adapters 58 face downwardly from the dome. The adapters 58 of the first row R1 are staggered relative to the adapters 58 of the second row R2 such that the adapters of the first row R1 align with spacings S between the adapters of the second row R2. In one example, the adapters can be push-pull adapters for use with push-pull connectors as disclosed by International Publication No. WO2021/203012, which is hereby incorporated by reference in its entirety.

Referring to FIGS. 1-4, the housing 401 includes a height H, a width W, and a depth D that are all arranged perpendicular to one another. The width W and the depth D are defined by the base 402. The adapters 58 are carried by the base 402 and mounted to an end wall 410 of the base 402 (e.g., mounted in openings such as openings 160 defined by end wall 410 of the base 402). In certain examples, the width W is at least two, two and a half, or three times as large as the depth D. The housing 401 includes a top end 412 and an opposite bottom end 414. The dome 404 defines the top end 412 and the end wall 410 defines the bottom end 414. The housing includes opposite major sides 416, 417 that extend between the top and bottom ends 412, 414 and across the width W and minor sides 418, 419 that extend between the top and bottoms ends 412, 414 and across the depth D. Locking sleeves 22 each define a cross-dimension CD. In one example, the cross-dimension CD is at least 30 percent, or at least 35 percent, or at least 40 percent as large as the depth D. In one example, when viewed from one of the minor sides 418, 419, the locking sleeves 22 of the first and second rows R1, R2 overlap by at least 5 percent, 10 percent, 15 percent, or 20 percent of the cross-dimension CD. In one example, when viewed from one of the major sides 416, 417, the locking sleeves of the first and second rows R1, R2 do not overlap and are separated by open gaps G. In one example, the open gaps G have dimensions in the range of 2 to 20 percent or 2 to 10 percent of the cross-dimension CD. In one example, when viewed from bottom end 414, the adapters 58 have a spacing S between other neighboring adapters 58 in their respective rows R1, R2. The adapters 58 of R1 are centered about the gap S of adapters 58 in R2 and vice-versa.

In certain examples, fiber optic connectors used in devices in accordance with the principles of the present disclosure can include ferruled fiber optic connectors (e.g., single fiber or multi-fiber) and ferrule-less (e.g., bare-fiber) fiber optic connectors (e.g., single or multi-fiber). Example bare fiber connection systems are disclosed by International Publication Nos. WO 2012/112344; WO 2013/117598; WO 2016/043922; WO 2017/081306; WO 2016/100384; WO 2020/046709; WO 2020/112645; WO 2021/163063; and WO 2018/144128, all of which are hereby incorporated by reference in their entireties.

Further details regarding the adapter 58, the fiber optic connector 24, and the locking sleeve 22 are disclosed by International Publication No. WO2021/041305 which is hereby incorporated by reference in its entirety.

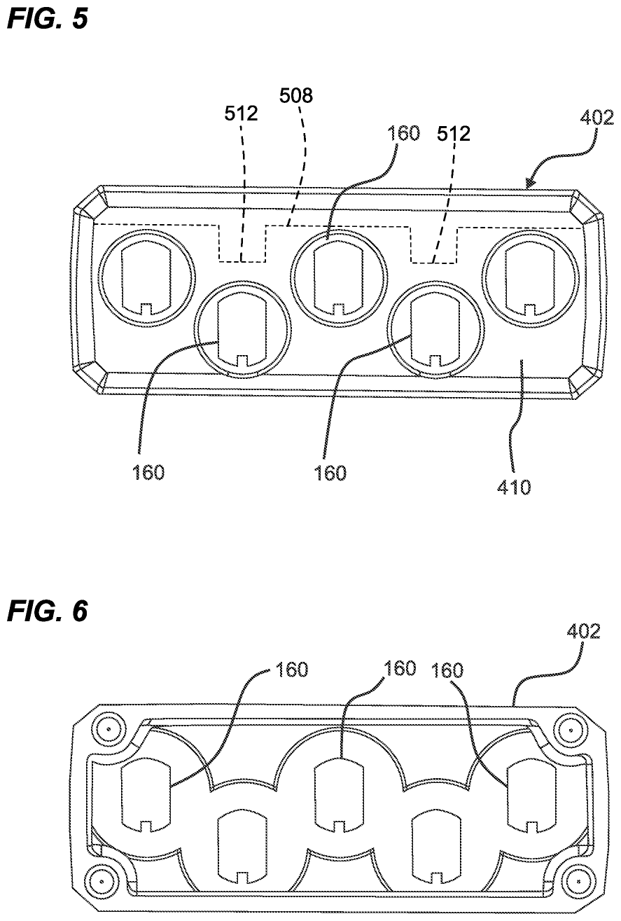

Referring to FIGS. 5 and 6, the staggering of the openings 160 for mounting the adapters 58 in the base 402 is depicted.

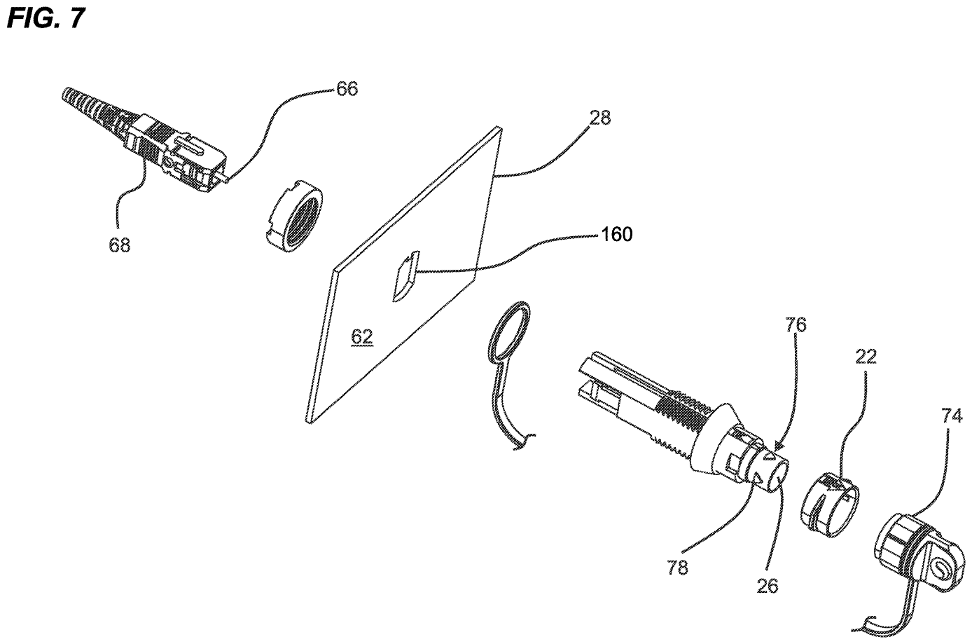

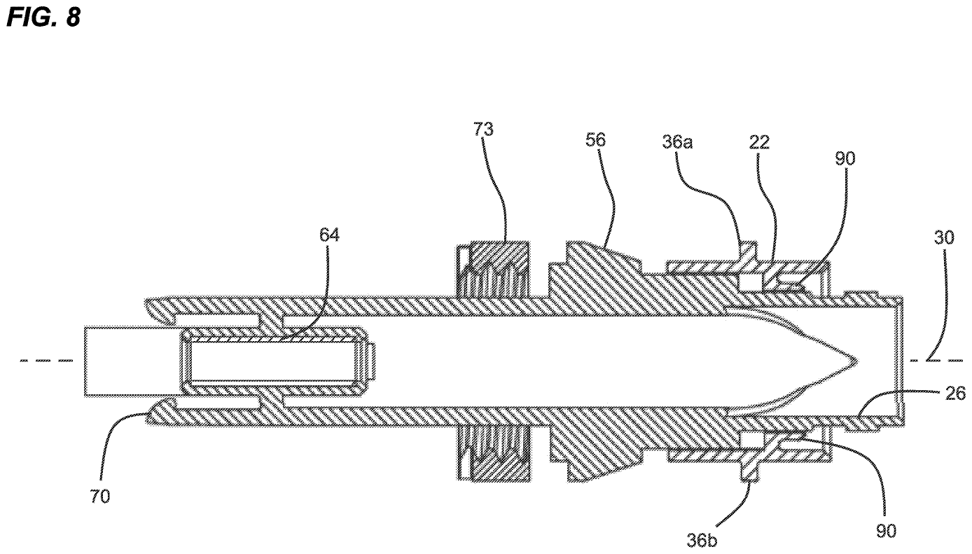

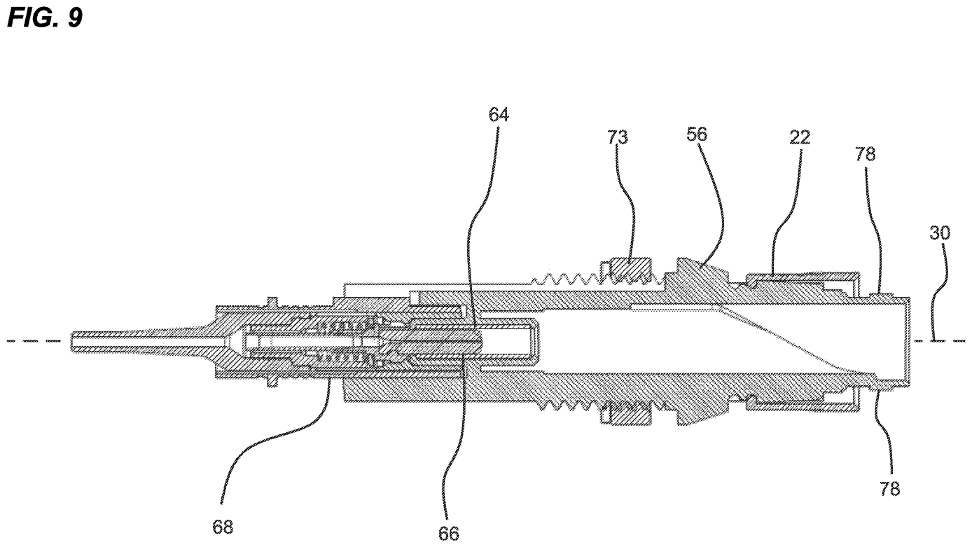

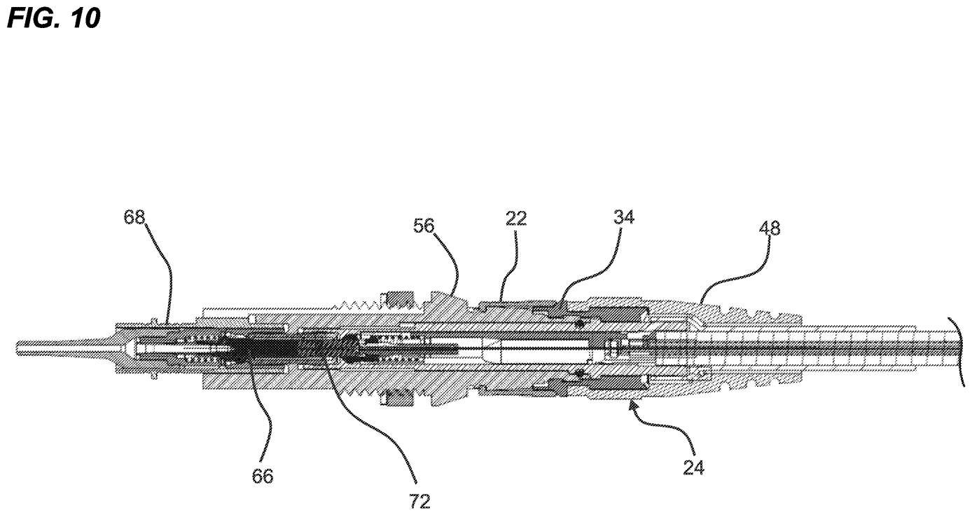

Referring to FIGS. 7-9, outer connector ports 26 are defined by adapter bodies 56 of the fiber optic adapters 58. A ferrule alignment sleeve 64 is mounted within each adapter body 56. The ferrule alignment sleeve 64 is configured for coaxially aligning a ferrule 66 of an inner fiber optic connector 68 installed within an inner end 70 of the adapter body 56 with a ferrule 72 of the outer hardened fiber optic connector 24 (see FIG. 10). A fastener 73 can thread on the adapter body 56 to secure the adapter body 56 to the wall 410 within the opening 160. A dust cap 74 can be provided for enclosing the outer connector port 26 when the outer connector port 26 is vacant. The locking sleeve 22 mounts on the adapter body 56 around the outer connector port 26. The locking sleeve 20 is non-rotationally mounted on the adapter and is configured to move axially relative to the adapter body 56 between the locking position and the non-locking position. The adapter body 56 also defines a first rotational interlock arrangement 76 at an exterior of the adapter body 56. The first rotational interlock arrangement 76 includes a plurality of interlock members 78 located at the exterior of the adapter body 56 that are circumferentially spaced about the port axis 30.

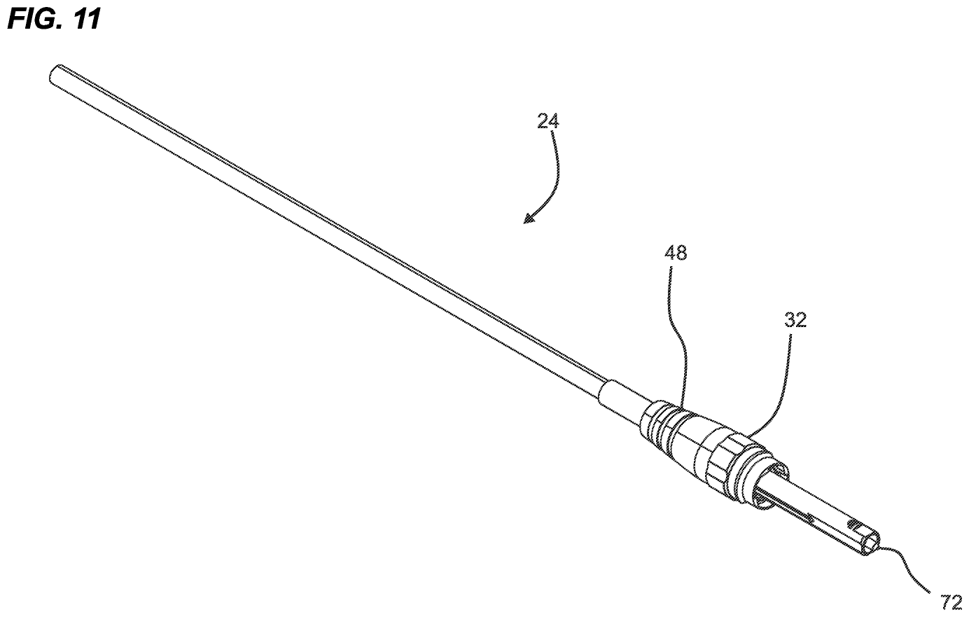

Fiber optic connectors 24 (see FIG. 11) are adapted to be installed in the outer connector ports 26 from outside the enclosure 28. A rotatable fastener 32 of each fiber optic connector 24 includes a second rotational interlock arrangement 80 adapted to interlock with the first interlock arrangement 76 to secure the fiber optic connector 24 within the outer connector port 26. When the fastener 32 is rotated to interlocked position, the locking sleeve 20 is moved axially from the non-locking position to the locking position to prevent the fastener from being rotated from the interlocked position back to the non-interlocked position. By axially moving the locking sleeve to the non-locking position, the fastener 32 can be rotated from the interlocked to the non-interlocked position to allow the connector to be removed from the corresponding outer connector port 26.

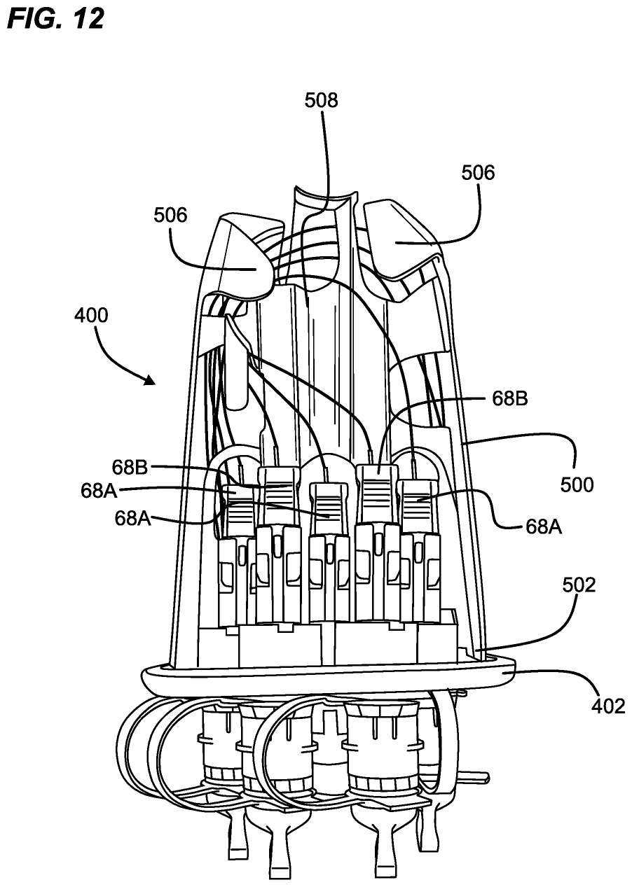

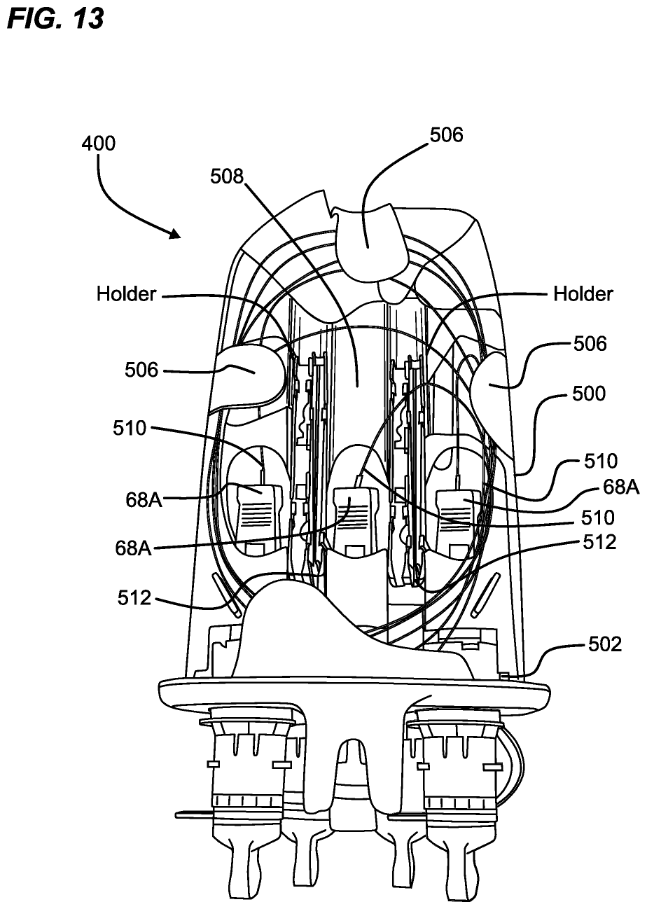

Referring to FIGS. 12 and 13, the enclosure 400 can include a manager frame 500 (e.g., a vertical tray) for managing optical fibers and optical components within the dome 404. The manager frame 500 includes a base end 502 that attaches to the base 402 of the housing 402 and a free end 504 that fits within the dome 404 and is curved to assist in fiber routing. The manager frame 500 includes structure defining an envelope for accommodating excess fiber length of optic fibers corresponding to the fiber optic connectors 68 (e.g., fiber optic connectors 68a corresponding to the second row R2 and fiber optic connectors 68b corresponding to the first row R1) mounted in the inner ports of the adapters 58 mounted to the base 402. The optical fibers are preferably stored in a looped configuration within the envelope and the manager frame 500 can include fiber retention tabs 506 for assisting in retaining the optical fibers within the envelope. The manager frame 500 also includes a vertical wall 508 that extends upwardly in an orientation along the height H from the base 402 and also extends across the width W of the housing 402. The vertical wall 508 extends outside the fiber optic connectors 68a corresponding to the row R2 of fiber optic adapters 58 (e.g., between the connectors 68a of the row R2 and the adjacent major side 416 of the housing 402). The vertical wall 508 can define openings 510 aligned with the fiber optic connector 68a of the row R2 to enhance finger access to the connectors (e.g., to release sleeves of the connectors as shown herein in which the fiber optic connectors 68 are depicted as SC connectors). The vertical wall 508 also includes component receivers 512 in alignment with the spacings S between the adapters 58 of the row R2 and their corresponding fiber optic connectors 68a. The component receivers 512 are depicted as channels such as vertical channels that are aligned with the spacings S. The component receivers 512 are adapted to receive components such as holders for holding optical splice packages, passive optical splitter packages, optical tap packages, wavelength divisional multi-plexer packages or the like. The component receivers 512 allow optical components to be positioned in space between the connectors 68a of the row R2 that correspond to the spacings thereby maximizing space utilization within the dome 404. The locations for the component receivers 512 are shown schematically at FIG. 6. Connectors 68b of the first row R1 align with the spacings S and the component receivers 512.

1. A fiber optic device comprising:
an enclosure including a housing having a base and a dome that mounts to the base, the housing including a height, a width, and a depth that are all arranged perpendicular to one another, the housing including a top end and an opposite bottom end, the dome defining the top end and an end wall of the base defining the bottom end;
the base defining first and second rows of adapter mounting openings in which fiber optic adapters are mounted, the adapter mounting openings of the first row being staggered relative to the adapter mounting openings of the second row;
fiber optic connectors installed within inner ports of the fiber optic adapters; and
a fiber optic component holder positioned in a space between at least two adjacent ones of the fiber optic connectors installed within the inner ports of fiber optic adapters of corresponding to one of the first or second rows of adapter mounting openings.

2. The fiber optic device of claim 1, wherein the adapter mounting openings of the first row overlap the fiber optic adapter openings of the second row in a dimension that extends along the depth, wherein the adapter mounting openings of the first row are spaced apart from one another along the width of the housing, and wherein the adapter mounting openings of the second row are spaced apart from one another along the width of the housing.

3. The fiber optic device of claim 1, further comprising a fiber manager attached to the base including at least one vertical wall defining at least one channel for receiving the fiber optic component holder to retain the fiber optic component holder at the space between the adjacent ones of the fiber optic connectors.

4. The fiber optic device of claim 3, wherein the channel is vertical and the fiber optic component holder is oriented vertically.

5. The fiber optic device of claim 1, further comprising a manager frame for managing optical fibers and optical components within the dome, wherein the manager frame includes a base end that attaches to the base of the housing and a free end that fits within the dome and is curved to assist in fiber routing, the manager frame including structure defining an envelope for accommodating excess fiber length corresponding to the fiber optic connectors mounted in the inner ports of the fiber optic adapters, the manager frame also includes a vertical wall that extends transversely outwardly from the base and also extends across the width of the housing, the vertical wall defining openings aligned with one or more of the fiber optic connectors to enhance finger access to the fiber optic connectors, the vertical wall also including component receivers in alignment with spacings between the adapters of one of the first or second rows, wherein the fiber optic component holder is positioned within one of the component receivers.

6. The fiber optic device of claim 5, wherein the component receivers are vertical channels.

7. A fiber optic device comprising:
an enclosure including a housing having a base and a dome that mounts to the base, the housing including a height, a width, and a depth that are all arranged perpendicular to one another, the width and the depth being defined by the base, the width being at least two times as large as the depth, the housing including a top end and an opposite bottom end, the dome defining the top end and an end wall of the base defining the bottom end, the housing including opposite major sides that extend between the top and bottom ends and across the width and minor sides that extend between the top and bottoms ends and across the depth;
wherein the enclosure includes a plurality of connector ports each defining a port axis, the enclosure including first rotational interlock arrangements corresponding to each of the connector ports, the enclosure also including locking sleeves corresponding to each of the connector ports, the locking sleeves being axially movable along the port axes between locking positions and non-locking positions, the connector ports being defined by fiber optic adapter bodies carried by the base and mounted to the end wall of the base, the locking sleeves being mounted on the fiber optic adapter bodies, the connector ports and the locking sleeves each defining a cross-dimension that is at least 30 percent as large as the depth, the connector ports being aligned in first and second rows that extend across the width of the enclosure, wherein when viewed from one of the minor sides, the locking sleeves of the first and second rows overlap by at least 5 percent of the cross-dimension, and wherein when viewed from one of the major sides, the locking sleeves of the first and second rows do not overlap and are separated by open gaps.

8. The fiber optic device of claim 7, wherein the open gaps have dimensions in the range of 2 to 20 percent of the cross-dimension.

9. The fiber optic device of claim 7, wherein the locking sleeves of the first and second rows overlap by at least 10 percent of the cross-dimension.

10. The fiber optic device of claim 7, wherein the locking sleeves of the first and second rows overlap by at least 15 percent of the cross-dimension.

11. The fiber optic device of claim 7, wherein the locking sleeves of the first and second rows overlap by at least 20 percent of the cross-dimension.
